(19) United States
(12) Patent Application Publication
(10) Pub. No.: US 2022/0414820 A1
(43) Pub. Date: Dec. 29, 2022

(54) METHOD OF INSERTING AN OBJECT INTO A SEQUENCE OF IMAGES

(71) Applicant: MOVE AI LTD, London (GB)

(72) Inventors: Nikolaos Zikos, Thessaloniki (GR); Tino Millar, London (GB)

(21) Appl. No.: 17/787,581

(22) PCT Filed: Dec. 18, 2020
(86) PCT No.: PCT/GB2020/053303

§ 371 Date: Jun. 20, 2022

(30) Foreign Application Priority Data
Dec. 20, 2019 (GB) 1919027.1
Mar. 13, 2020 (GB) 2003639.8

(51) Int. Cl. G06T 3/00; G06T 11/00; G06T 3/60; G06T 7/60; G06T 7/32; G06T 7/11; G06T 7/194; G06T 7/70

(52) U.S. Cl. CPC G06T 3/0068; G06T 11/00; G06T 3/0093; G06T 3/60; G06T 7/60; G06T 7/32; G06T 7/11; G06T 7/194; G06T 7/70; G06T 2207/10016; G06T 2207/20221

(57) ABSTRACT

The invention relates to a method of inserting an insertion object into a sequence of images. The insertion object may be an image, a video, or a three-dimensional model, which could possibly be animated. Particularly, but not exclusively, the invention relates to the insertion of advertisement images into video, such as videos of sporting events. A method comprises capturing a sequence of images, the sequence of images comprising in order a first image, a second image, and a third image; estimating a first homographic transform from the first image to the third image; deriving a second homographic transform from the first image to the second image based on the first homographic transform; transforming the insertion object using the first homographic transformation to form a first warped insertion image, and inserting the first warped insertion image into the third image of the sequence of images; and transforming the insertion object using the second homographic transformation to form a second warped insertion image, and inserting the second warped insertion image into the second image of the sequence of images.

The invention relates to a method of inserting an insertion object into a sequence of images. The insertion object may be an image, a video, or a three-dimensional model, which could possibly be animated. Particularly, but not exclusively, the invention relates to the insertion of advertisement images into video, such as videos of sporting events.

It is desirable to be able to insert advertisements into a video in a manner that locates and transforms them to match a fixed part of the scene. For example, a particular insertion region of a planar wall might typically be selected. One task is to insert a digital advertisement image into that insertion region in such a way that it appears to be a real printed item (for example, a poster) located on that insertion region of the real wall.

There are many challenges in inserting objects into video in this way.

Firstly, it is difficult to identify in each frame of the video the rotation of the region of the wall (i.e., the rotation of the camera) in the real world, because the camera may not be directed perpendicular to the wall in all frames. When the camera is facing the wall, the insertion region would appear rectangular, but when the camera is facing at an acute angle the wall, the insertion region would appear trapezoidal. It is necessary to warp the insertion image to match the apparent shape of the insertion region.

Secondly, it is difficult to identify the target pixels in each frame of the video that represent the insertion region, because the insertion region may be occluded in various locations at points in the video. For example, a person may stand in front of the wall. It is not sufficient to place the inserted object over the person, it must be edited so as to be inserted only where the insertion region can be seen.

Thirdly, it is difficult to insert the insertion object in a way that appears natural. In some cases this is because of features in the video such as motion blur and, optionally, other effects such as rain.

There is a need for an effective method for inserting objects into video in a fast manner that produces a natural appearance.

Some aspects of the invention are set out in the claims.

For a better understanding of the invention and to show how the same may be put into effect, reference will now be made, by way of example only, to the accompanying drawings in which:

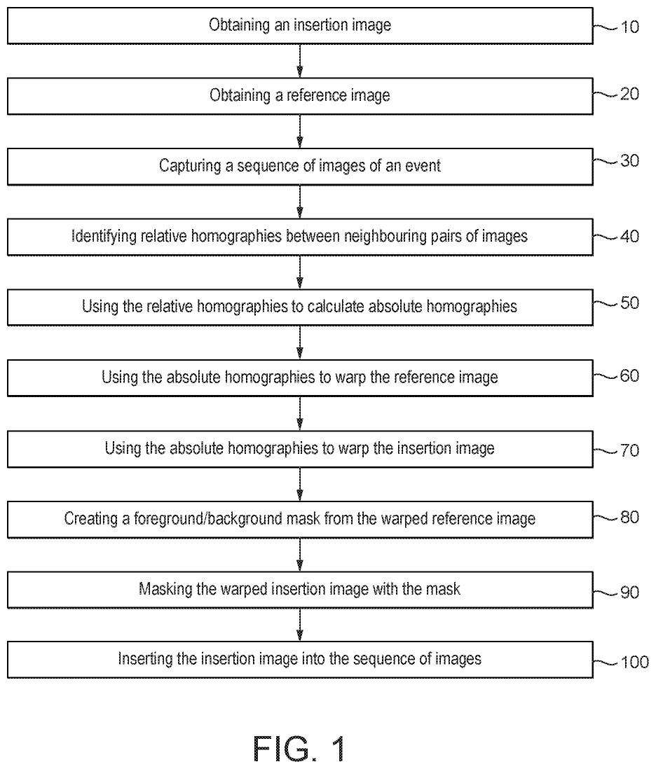

FIG. 1 is a flow chart of a method of inserting an object into a sequence of images;

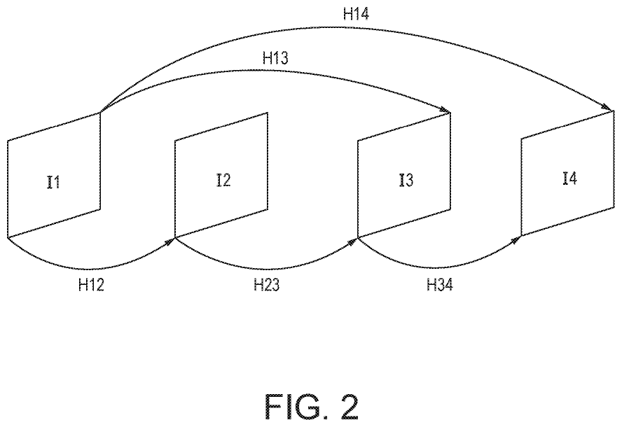

FIG. 2 is a schematic representation of a sequence of images depicting relative and absolute homographies;

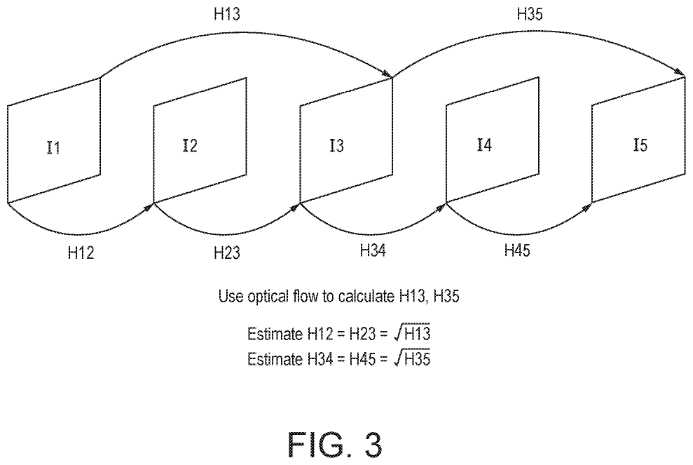

FIG. 3 is a schematic representation of a sequence of images depicting estimation of intermediate homographies;

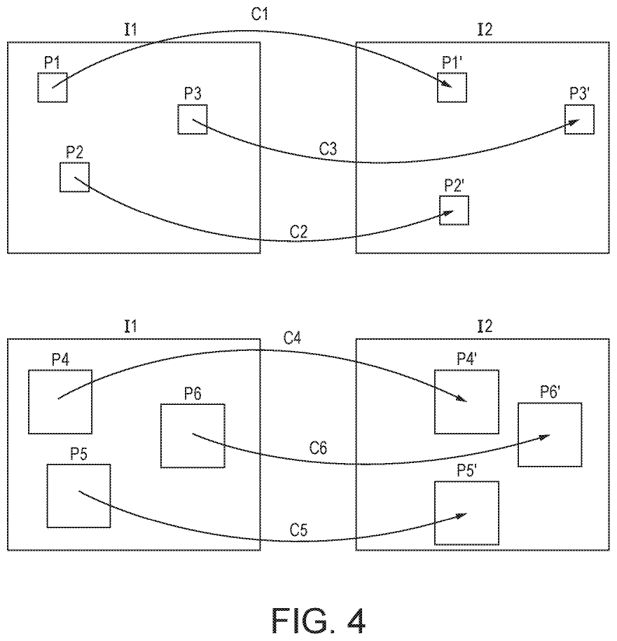

FIG. 4 is a schematic representation of a two-step optical flow algorithm;

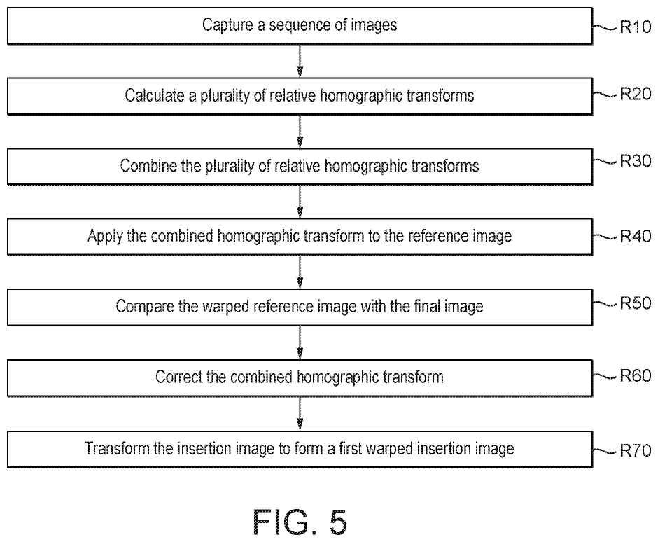

FIG. 5 shows a flow chart explaining the use of an absolute homography to warp an insertion image;

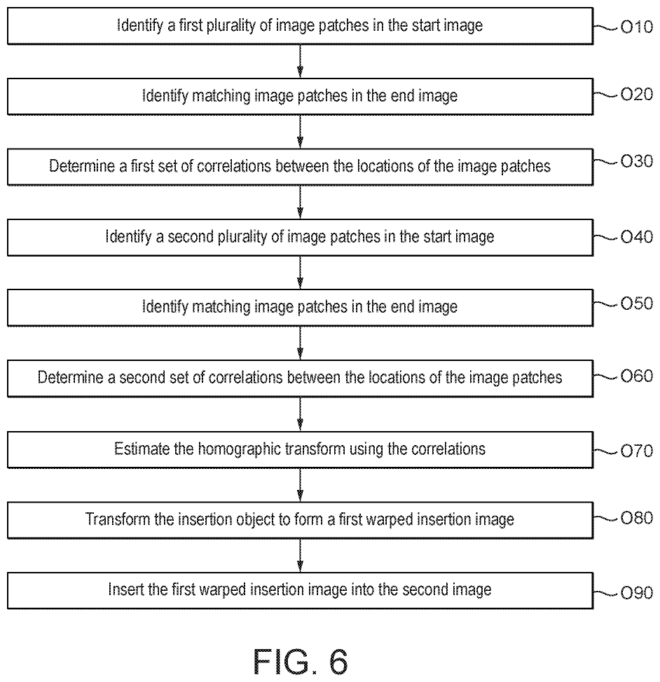

FIG. 6 shows a flow chart showing a two-step optical flow algorithm;

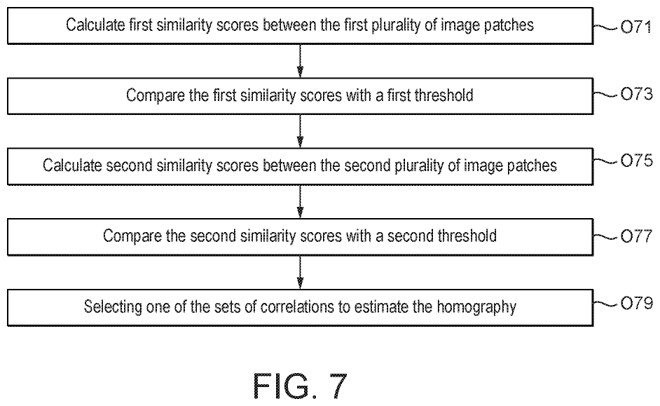

FIG. 7 shows a flow chart showing an optional way of combining the two steps of the two-step optical flow algorithm;

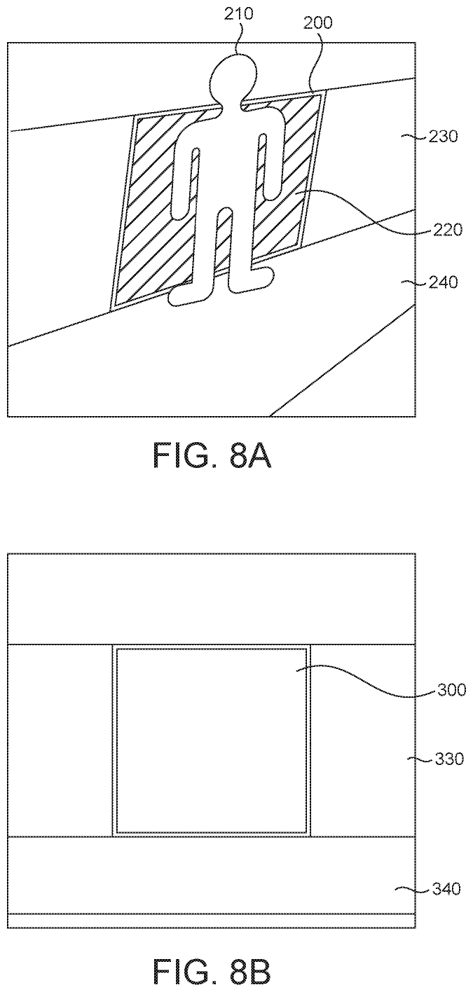

FIG. 8a shows an example of a mask for an image in a sequence of images;

FIG. 8b shows an example of a reference image for comparison with FIG. 8a;

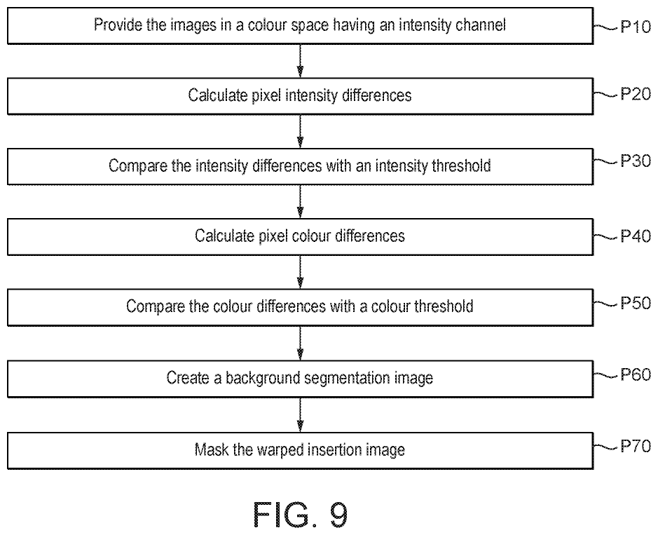

FIG. 9 shows a flow chart showing a foreground/background detection algorithm;

### OVERVIEW—HARDWARE

The following methods will be implemented on one or more computer processors that are connected to one or more data storage devices using one or more cameras. Of course, the cameras may be used by a different entity from the computer processors. Accordingly, reference to capturing an image includes both capturing the image directly using a camera, and also receiving the image from a third party.

The cameras may move both in translation and rotation. The concept of homography, discussed below, captures both affine transformations (in-plane transformations such as scaling and translation, etc) and camera rotations (out-of-plane rotations).

The methods discussed are ideal for inserting objects such as images into sequences of images that have been captured in uncontrolled situations without physical measurement of camera position and orientation, even those outside of a studio environment.

Overview—Method

With reference to FIG. 1, there can be seen an overview of a method of inserting an object into a sequence of images. The method can be summarised as follows.

In step 10, an insertion object is obtained. Unless the object is an image, an insertion image is generated from the object.

In example embodiments, the insertion object is simply an insertion image. The insertion image may be an advertisement that a customer would like to be present in a video of an event such as a sporting event. The insertion image must be modified before insertion into the sequence of images. Potentially, the insertion image may need to be modified differently for insertion into each image of the sequence of images. However, the same insertion image is modified (where necessary) to produce the modified insertion image for insertion into each image of the sequence of images.

In other embodiments, the insertion object may be an insertion video. The insertion video may comprise a plurality of sequential frames for insertion into corresponding sequential images of the sequence of images. Each frame of the insertion image must be modified before insertion into the respective image of the sequence of images. Potentially, each frame of the insertion video must be modified differently for insertion into the corresponding image of the sequence of images. In this way, each frame of the insertion video can be considered an insertion image, but a different insertion image (a different frame of the video) is modified where necessary to produce the modified insertion image for insertion into each image of the sequence of images.

In example embodiments, the insertion object is a three-dimensional model, potentially an animated three-dimensional model. The customer may wish the three-dimensional model to appear in the sequence of images as if it were present in the scene. A projection of the three-dimensional model at a particular moment in time may be calculated to produce an insertion image for each image of the sequence of images. In this way, a different insertion image (a different projection of the three-dimensional model) is modified where necessary to produce the modified insertion image for insertion into each image of the sequence of images.

In step 20, a reference image is obtained. The reference image is a single image captured of the location where the insertion image is to be inserted. The reference image is preferably captured in a calibration method that precedes the method of inserting the insertion object. The reference image may be labelled to identify an insertion region where the insertion object is to be inserted. The reference image may be selected by a human operator to be free of foreground objects. The reference image (suitable transformed) can be used for comparison with a selected image of the sequence images to identify a location in the selected image for the insertion of the insertion object. The reference image (suitable transformed) can be used for comparison with a selected image of the sequence images to identify foreground objects for the masking of the insertion object.

It is preferred that the insertion image is aligned with the reference image in the sense that it could be inserted directly into the reference image and appear to be correctly aligned with the scene (it appears as though it has been captured from the same angle as the reference image, although the insertion image may of course be artificial).

In step 30, a sequence of images of an event is captured. For example, the event may be captured in real time, and the sequence of images may be a real time video stream.

As an illustrative example, the sequence of images may be a live stream of video from a motor race. A reference image may be an image of the race track, free of cars. A surface alongside the track may be an insertion region in which an advert is to be inserted. The manually-operated camera producing the sequence of images may follow a car along the track. In doing so, the shape of the insertion region will vary based on the change of angle of view of the camera. At some point, the car will pass between the camera and the insertion region of the surface alongside the track, occluding a portion of the insertion region in the image captured by the camera. The variation in images including the insertion region as the camera rotates enables the correct transformation of the reference image to be identified (discussed below in connection with step 50). The transformed reference image can be compared with the image captured by the camera to identify matching pixels as image background and differing pixels as image foreground.

In step 40, a relative homography for each neighbouring pair of images in the sequence of images is calculated. Each relative homography may be calculated by determining the optical flow between the neighbouring pair of images (optical flow is discussed further below). A homography is a mathematical representation of the warping of the image due to the rotation of the camera (for example, it defines a change in position of a vanishing point or, put another way, it defines the angles between lines in the image that represent lines that are parallel in the real world). Homographic transforms are discussed in the book “Multiple View Geometry in Computer Vision” by Hartley and Zisserman, Cambridge University Press, 2000.

A relative homography is calculated between each image and the following image represents how the camera rotated between images. The relative homography is preferably represented as a three by three matrix, as is known in the art.

In step 50, an absolute homography is calculated using the relative homographies. An absolute homography is calculated for each image in the sequence of images by determining the cumulative effect of the relative homographies for all of the preceding image pairs to identify a homography between that image in the sequence of images and the first image in the sequence of images.

An illustration of this is shown in FIG. 2, in which the relative homography between image I1 and image I2 is H12, and the relative homography between image I2 and image I3 is H23. H12 and H23 cumulatively represent H13, which is the absolute homography from the first image I1 to image I3. Similarly, the relative homographies H12, H23, and H34 cumulatively represent H14, which is the absolute homography from the first image I1 to image I4.

One way of estimating an absolute homography is to find the product of the preceding relative homographies. For example, the relative homographies preceding a particular image may each be represented as a matrix, and the product of those matrices will be equal to the absolute homography from the starting image to that image.

For example, with reference to FIG. 2, the absolute homography H14 for image I4 could be estimated as the product of the matrices representing relative homographies H12, H23, and H34.

In step 60, the absolute homographies are used to warp the reference image to produce warped reference images corresponding to each image of the sequence of images. If the reference image is aligned with the first image of the sequence (the cameras were at the same angle when both images were captured), then the absolute homography is applied directly to the reference image.

On the other hand, if the reference image is not aligned with the first image of the sequence (the cameras were at different angles when both images were captured), then a compensation homography compensating for that difference is applied to the reference image in addition to the absolute homography. Alternatively, the absolute homography may be calculated to include the effect of the compensation homography (in which case, it is an estimate of the homography between the reference image and each image of the sequence of images).

A warped reference image may be produced for a plurality of sequential images in the sequence of images. This can have the effect of modifying the reference image to produce warped reference images that each appear as if they had been captured from an angle matching that of the respective image of the sequence of images.

In this way, a sequence of warped reference images may be generated for comparison with corresponding images in the sequence of images.

In step 70, the absolute homographies can be used to warp the insertion image in the same way as the reference image.

In the case of insertion of an insertion object in the form of a video, step 60 involves forming an insertion image by extracting a frame of the video into and warping the insertion image using the absolute homography.

In the case of insertion of an insertion object in the form of a three-dimensional model, step 60 involves forming an insertion image by generating a projection of the three-dimensional model into and warping the insertion image using the absolute homography.

A warped insertion image may be produced for a plurality of sequential images in the sequence of images. This can have the effect of modifying the insertion image to produce warped insertion images that each appear as if they had been captured from an angle matching that of the respective image of the sequence of images.

If the insertion image is aligned with the first image of the sequence (the cameras were at the same angle when both images were captured), then the absolute homography is applied directly to the insertion image.

On the other hand, if the insertion image is not aligned with the first image of the sequence, then a compensation homography compensating for that difference is applied to the insertion image in addition to the absolute homography. Alternatively, the absolute homography may be calculated to include the effect of the compensation homography (in which case, it is an estimate of the homography between the insertion image and each image of the sequence of images), and also the insertion image is aligned with the reference image.

In step 80, a foreground/background mask is created for each warped insertion image using the warped reference image. This can be done by comparing the warped reference image with the corresponding image in the sequence of images (discussed in more detail below). Where the two images differ, then the pixel can be labelled in the foreground/background mask as foreground, and where the two images match, the pixel can be labelled as background. This is preferably done just for the insertion region (as it appears in the warped reference image).

In step 90, each warped insertion image is masked using the foreground/background mask, to create a masked warped insertion image, with which a subset of pixels of the warped insertion image may be inserted into another image.

In this way, the masked warped insertion image may only comprise the pixels of the warped insertion image that correspond to a background pixel in the insertion region of the warped reference image. That is to say that the pixels of the warped insertion image that correspond to the foreground pixels in the insertion region of the warped reference image are not included, or are made transparent, in the masked warped insertion image.

Indeed, since only the insertion region is important for the insertion of the insertion image, it is unimportant that the warping process can lead to uncertain pixel values around the resulting warped image.

In step 100, each of the masked warped insertion images is inserted into the corresponding image of the sequence of images. Owing to the masking step, in each image of the sequence of images, any foreground objects that occlude the insertion region are retained and the pixels corresponding to the visible part of the insertion region are replaced by the pixels of the warped insertion image.

As will be apparent, the masked warped insertion image may be an image file that includes only the relevant pixels of the warped insertion image, or may be simply the juxtaposition of the warped insertion image and the data that defines which pixels are masked. The word “image” does not imply that the data is provided in a format such as jpeg, merely that image data is obtained that enable the relevant pixel values to be superimposed on another image. In this way, the method may comprise identifying a foreground/background mask and using the mask to select which pixels of the warped insertion image are to be inserted into the corresponding image of the sequence of images. The combination of the foreground/background mask and the warped insertion image can be considered a masked warped insertion image. A non-essential, but convenient format for the provision of the masked warped insertion image is PNG format, since this includes both red, green and blue channels, and also an alpha channel, which represents transparency, and so can be used for masking.

Whilst the above description presents a method as if it were carried out in a batch for all images of the sequence of images, in practice, it is more likely that the method would be carried out one image of the sequence of images at a time. For example, the method can be carried out in real-time as the sequence of images is captured and the insertion image inserted into each of the images at the rate at which they are captured.

An illustrative example is shown in FIGS. 8a and 8b. FIG. 8a is an image of the sequence of images, which has been captured at an angle to a wall 230. The insertion region 200 in FIG. 8a, which may be a location for a poster, is trapezoidal in shape. FIG. 8b shows a reference image, which has been captured facing the wall 230. The insertion region 300 in FIG. 8b is rectangular in shape.

FIG. 8a shows an insertion region 200, which represents a region of a wall 230. A person 210 is standing on a path 240 in front of the wall occluding part of the insertion region 200.

The shaded the region which indicates where the insertion image should be inserted is labelled as 220.

The application of a homographic transform to the reference image of FIG. 8b can transform the image such that the insertion region 300 is warped into a trapezoidal shape.

That trapezoidal insertion region 300 can be compared with the image of FIG. 8a to identify the pixels for insertion of the insertion image 220, so as to create the mask.

The following describes sub-methods that may be used in other contexts, but are particularly advantageous in the context of the method described in the overview set out above.

Relative to Absolute Homography

In order to identify a homography to transform the reference image such that it matches a particular target image in the sequence of images, the homography has to represent the rotation of the camera from the direction in which the reference image was captured to the direction in which the target image was captured.

In this disclosure a relative homography is a homography transformation as between a pair of images in the sequence of images, and represents the rotation of the camera between the directions in which the pair images were captured. An absolute homography is a homography relative to a particular image, such as the first image in the sequence of images or a reference image. Preferably, the first image in the sequence of images and the reference image are captured by a camera directed in the same direction such that the absolute homography is relative to both the first image in the sequence of images and the reference image. The first image may be, for example, the start of a broadcast of an event.

For the optical flow method to be most effective, a large similarity between the two images used to estimate a homography is beneficial. The smaller the rotation between images, the more accurately the image patches may be matched in each image. Put another way, a homography estimated between the first and second image is more likely to be accurate than a homography estimated between the first and tenth images, because the image patches matched between the first and second images will be more similar and more accurately located than the image patches matched between the first and tenth images.

From the sequence of images, sequential pairs of images, such as neighbouring pairs, or pairs spaced apart by two, three or four images, are selected. The pairs of images overlap such that the second image of each pair is used as the first image of the next pair. Relative homographies may be calculated as between the successive pairs of images, to provide a continuous set of relative homographies from a first image to a last image. The continuous set of relative homographies provide a set of transforms from the first image to the last image via each pair of images.

The set of relative homographies is continuous, and each defines a transform from a starting point of one pair of images to the starting point of the next pair of images. Thus, the cumulative effect of the homographic transforms of the continuous set of relative homographies is an absolute homography as between the first image and the last image. It is therefore possible to combine the continuous set of relative homographies between the first image and the last image to estimate an absolute homography between the first image and the last image. Inaccuracies will be introduced into this estimated absolute homography by the cumulative effect of the errors in calculating each of the relative homographies.

The reference image can be used to lessen and/or remove the inaccuracies. Since the reference image is aligned with the first image (or can be aligned to the first image), it is possible to calculate a warped reference image using the estimated absolute homography.

The warped reference image can be compared with the last image to calculate a residual. From the residual, it is possible to calculate a refinement of the estimated absolute homography.

One way of doing this is to calculate the residual homography from the warped reference image to the last image. This can be determined, for example, using the optical flow calculated between the warped reference image and the last image. The residual homography can be used to refine the estimated absolute homography, for example, by multiplication. That is, the refined estimated absolute homography may be the product of the estimated homography and the residual homography.

This method works well because the refined estimated absolute homography might represent a large camera movement, but each homography that is used to calculate the refined estimated absolute homography is based on only a small change in each image and so the homography estimation can be accurate.

The process set out above can be used in a method of inserting an insertion object into a sequence of images, comprising the following steps.

In step R10, a sequence of images is captured from a first image to a final image.

In step R20, a plurality of relative homographic transforms is calculated. Each homographic transform is calculated based on successive pairs of the sequence of images from the first image to the final image. Each pair of images overlaps with its neighbour such that the second image of each pair is used as the first image of the next pair.

In step R30, the plurality of relative homographic transforms are combined to form a combined homographic transform.

In step R40, the combined homographic transform is applied to the reference image to form a warped reference image.

In step R50, the warped reference image is compared with the final image to form a residual homographic transform, which is the homographic transform from the warped reference image to the final image.

In step R60, the combined homographic transform is corrected based on the residual homographic transform to form a corrected homographic transform.

In step R70, the corrected homographic transform is used to transform the insertion image to form a first warped insertion image. The first warped insertion image may be masked. The first warped insertion image is then inserted into the second image of the sequence of images.

Homography Interpolation

As explained above, in step 40, a relative homography for each neighbouring pair of images in the sequence of images is estimated. One method of calculating a relative homography may comprise determining the optical flow between the neighbouring pair of images. This optical flow approach, and other known approaches, can be computationally expensive.

A way of reducing the computational expense is by using the optical flow approach to estimate a homography between pairs of images that are separated by an intervening image, and estimating a homography for the intervening pairs of neighbouring images.

For example, as shown in FIG. 3, it is possible to calculate the homography H13 based on any known method, such as the calculation of optical flow as between images I1 and I3. Similarly, it is possible to calculate the homography H35 based on any known method, such as the calculation of optical flow as between images I3 and I5. The homographies H13 and H35 may be represented as three by three matrices.

As explained with reference to FIG. 2, absolute homographies from the first image to the N^{th} image may be estimated as the product of each of the relative homographies of the pairs of images between the first and N^{th} images. The inventors have realised that the converse approach can be used as an estimation of relative homographies from an absolute homography.

That is, a first homographic transform H13 can be estimated as between the first image I1 and the third image I3 (or the third image I3 and fifth image I5, and so on).

By assuming that the two intervening relative homographies H12 and H23 are identical, it is possible to derive either of these from the first homographic transform. That is, a second homographic transform H12 from the first image to the second image can be derived mathematically using the assumption.

One way of deriving the second homographic transform H12 is by representing the first homographic transform H13 as a matrix, and finding the square root of the matrix—by this is meant the determination of the matrix square root (which is not the same as the square root of individual items within the matrix). It is possible to carry out the method in other ways, without representing the homographies as matrices, but those methods would be mathematically equivalent. Possible methods for finding a square root of a matrix are well known in the art and include the Schur method (Edvin Deadman, Nicholas J. Higham, Rui Ralha (2013) “Blocked Schur Algorithms for Computing the Matrix Square Root, Lecture Notes in Computer Science, 7782. pp. 171-182) or other methods, such as the Denman-Beavers iteration, Jordanian decomposition or the Babylonian iterative method.

Such a method can be used, for example, to calculate homographic transformations to be applied to insertion images to warp them in a manner that matches the image into which they are to be inserted.

That is, the insertion image can be transformed using the first homographic transformation H13 to form a first warped insertion image, which can be inserted into the third image I3, and the insertion image can be transformed using the second homographic transformation H12 to form a second warped insertion image, which can be inserted into the second image I2.

As is known in the art, some of the mathematical methods listed above can also be used to find other roots, such as the cube root or the fourth root, etc. Accordingly, the square root of a homography matrix, representing a transform from a first image to a third image, can be used to estimate a relative homographic transform from the first image to a second image between the first and third images. A cube root of a homography matrix, representing a transform from a first image to a fourth image, can be used to estimate (as identical) the two relative homographic transforms from the first image to the second image and from the second image to the third image.

In the general case, a homography between the first image of the sequence of images to the Nth image of the sequence of images, can be used to estimate a second homographic transform between each intervening pair of images between the first and Nth images, the second homographic transform being representable as a second homography matrix that is equal to the (N−1)th root of the first homography matrix.

Whereas the method above involves decomposing a first calculated homographic transform between a start image and an end image into a second homographic transform for intervening pairs of images in a mathematical sense by matrix manipulation, in fact, the same effect can be achieved geometrically. Indeed, the homographic transform defines the result of the translation and rotation of the camera in the image plane.

As such, it is not essential to represent the homographic transformation as a matrix and find the square root (or some other root) of that matrix. This happens to be computationally efficient. However, it is possible to represent the homographic transform in other ways, such as the translation and rotation of the camera, and interpolate the translation and rotation of the camera to estimate the homographic translations for intervening pairs of images. For example, the first homographic transform can be represented as a translation and rotation of a camera, and the second homographic transform can be estimated by deriving the homographic transform resulting from half the translation and half the rotation.

Mathematically, these methods are equivalent, but the first homographic transform is representable as a first homography matrix, and the second homographic transform is representable as a second homography matrix that is equal to the square root of the first homography matrix.

Interlaced Images

It is conventional in the field of TV broadcasts to transmit interlaced images.

An interlaced broadcast is the transmission of a sequence of interlaced images, the sequence of images comprising in order a first interlaced image, and a second interlaced image.

The first interlaced image includes a first captured image interlaced with a second captured image, with the second image captured after the first. For example, the first captured image may be the image captured using the odd (or even) rows of a CCD sensor inside a camera, and the second captured image may be the image captured using the even (or odd) rows of the CCD sensor. The first and second captured images are captured at different times, but interlaced to form a single interlaced image.

The second interlaced image includes a third captured image interlaced with a fourth captured image, with the fourth image captured after the third.

Thus, two interlaced images represent four sequential images of a series of images.

It is not as appropriate with interlaced images to form a homography between the first and second captured images, because the images were captured from different rows of the camera image sensor (e.g., a CCD). There would be an inherent error owing to the effectively different camera position in the two images because the rows are offset. However, every second image is captured by the same rows (odd or even), and so a homography calculated between the first and third images is meaningful and a homography calculated between the second and fourth images is meaningful.

However, the homographic transform between first and third images can be used in the method described above to estimate a homographic transform between the first and second image. That is, the first homographic transform from the first image to the third image can be used to derive the second homographic transform from the first image to the second image by a mathematical operation equivalent to finding the square root of the matrix representing the first homographic transform, or interpolating the translation and rotation of the camera.

Optical Flow

As discussed above, a homographic transform may be estimated using one of the known optical flow approaches. In particular, a number of optical flow approaches are available that compare images based on a plurality of localised comparisons, where the size of the locality is a parameter of the optical flow algorithm. The Lucas-Kanade approach is preferred, and forms the discussion below. For the Lucas-Kanade method, the size of the locality if the size of the image patch. In other methods, the size of the locality may be represented by the variance of a Gaussian operator.

It has been found that conventional optical flow approaches are only robust to camera rotations that are within a small range of speeds. It is possible to vary the parameters of the optical flow method, which will make it more effective for different speeds of rotation. In particular, the size of the locality varies how effective the optical flow algorithm is for different speeds of rotation. The locality parameter for the Lucas-Kanade algorithm is the size of the image patch.

With reference to FIG. 4, in a preferred method of using optical flow to estimate a homography between a start image I1 and an end image I2, a first plurality of image patches P1, P2, P3 are identified in the start image I1. By patch is meant a sub-region of the image.

As is known in the art, such image patches may be identified based on detecting “interesting” features in the image, such as corners, textures, edges, etc. For example, the image patches may be identified by detecting features in the image having frequency content above a threshold.

For each of the first plurality of image patches P1, P2, P3, a matching image patch P1′, P2′, P3′ is identified in the end image.

This may be done by identifying the patch P1′ in the end image I2 that most closely resembles the patch P1 identified in the start image I1. A similarity metric (for example, the level of correlation between patches) may be used to calculate a similarity score and the patch in the end image I2 with the highest similarity score chosen as the matching patch. Preferably, the similarity scores are normalised by size of patch.

Preferably, the similarity score for the chosen matching pair of image patches is compared with a threshold to either use or not use the pair to determine correlations between the start and end images.

These matches provide a first set of correlations C1, C2, C3 between locations in the start image I1 (where the first plurality of image patches P1, P2, P3 are located) and locations in the end image I2 (where the respective matching plurality of image patches P1′, P2′, P3′ are located).

The correlations provide sufficient information for the estimation of the homography between the start image and end image.

Although only three correlations have been depicted, at least six correlations are calculated. If at least nine correlations are calculated, the homographic transform can represent more types of camera motion. Preferably, a much larger number of correlations are calculated. In practice, at least 100 correlations are used.

As mentioned above, optical flow approaches are only robust to camera rotations that are within a small range of speeds. If it is necessary to identify optical flow a wider range of camera rotation speeds, then the following method can be used. In the following, two or more optical flow algorithms are applied and the optical flow estimated by each can be used to provide a more accurate estimate than either algorithm could provide. The optical flow algorithms may be the same but for having different parameters. For example, the first optical flow algorithm and the second optical flow algorithm may differ in the size of the image patches used to estimate the optical flow. Alternatively, or in addition, the first optical flow algorithm and the second optical flow algorithm may differ in the threshold applied to identify a match between image patches in the start and end images.

The results of the two optical flow algorithms may be fused in some way (e.g., averaged), or the method may select one of the outputs of the two optical flow algorithms and disregard the other. This selection of one of the results of the two algorithms may be achieved by generating a confidence score for the set of correlations produced by each algorithm and picking the set of correlations with the highest confidence score.

In accordance with this approach, a method of inserting an insertion object into a sequence of images, comprises capturing a sequence of images, the sequence of images comprising in order a start image and an end image and estimating a homographic transform from the start image to the end image. The step of estimating the homographic transform comprises calculating at least two optical flow estimates between the start and end images.

In step O10, a first plurality of image patches having a first size are identified in the start image.

In step O20, for each of the first plurality of image patches a matching image patch is identified in the end image. For example, each first image patch in the start image may be considered to match the image patch in the end image for which the similarity score for the two patches is greatest. Preferably, the similarity score for the match must also exceed a minimum similarity threshold.

In step O30, a first set of correlations is determined between the locations of the first plurality of image patches in the start image and the locations of the respective matching image patches in the end image.

In step O40, a second plurality of image patches having a second size are identified in the start image. The second size is larger than the first size.

In step O50, for each of the second plurality of image patches a matching image patch is identified in the end image. For example, each second image patch in the start image may be considered to match the image patch in the end image for which the similarity score for the two patches is greatest. Preferably, the similarity score for the match must also exceed a minimum similarity threshold.

In step O60, a second set of correlations is determined between the locations of the second plurality of image patches and the locations of the respective matching image patches in the end image.

In step O70, the homographic transform is estimated using at least one of the first and second sets of correlations. For example, one of the first and second sets of correlations may be selected by a method having steps O71 to O79.

In step O71, a first similarity score is calculated between each of the first image patches in the start image and the respective matching image patches in the end image.

In step O73, each of the first similarity scores is compared with a first threshold to provide a first confidence score for the first set of correlations. For example, the first confidence score may be the number of image patches for which a match can be found that is similar enough that the similarity score exceeds the first threshold. Preferably, the first threshold is the same threshold used in step O20 to determine a match between image patches in the start and end images (if such a threshold is used). As an alternative example, the first confidence score may be the sum of the amounts by which the similarity scores of matching image patches exceeds the first threshold.

In step O75, a second similarity scores is calculated between the second plurality of image patches in the start image and the respective matching image patches in the end image.

In step O77, each of the second similarity scores is compared with a second threshold to provide a second confidence score for the second set of correlations. For example, the second confidence score may be the number of image patches for which a match can be found that is similar enough that the similarity score exceeds the second threshold. Preferably, the second threshold is the same threshold used in step O50 to determine a match between image patches in the start and end images (if such a threshold is used). As an alternative example, the second confidence score may be the sum of the amounts by which the similarity scores of matching image patches exceeds the second threshold.

The similarity scores may be normalised so that they are comparable independently of the size of image patch. In which case, it is preferable that the second threshold is bigger than the first threshold.

In step O79, the step of estimating the homographic transform comprises using the one of the first and second sets of correlations that has the highest associated confidence score.

In step O80, the insertion object is transformed using the homographic transformation to form a first warped insertion image.

In step O90, the first warped insertion image is inserted into the second image of the sequence of images.

The above approach of using two optical flow algorithms, with different sized image patches, can be extended to three or more optical flow algorithms. It is preferable that the threshold used for each optical flow algorithm is related to the size of the image patch, so that optical flow algorithms using larger image patches use larger thresholds.

Adaptive Chroma Keying

In step 80, a foreground/background mask may be created for each warped insertion image by comparing the warped reference image with the corresponding image in the sequence of images on a pixel by pixel basis. This is possible, because the transformation of the reference image into the warped reference image aligns the features of the reference image with the locations of equivalent features in the corresponding image of the sequence of images.

Where the two images differ, then the pixel can be labelled in the foreground/background mask as foreground, and where the two images match, the pixel can be labelled as background. This is preferably done just for the insertion region (as it appears in the warped reference image).

For illustration, FIG. 8a shows an insertion region 200, which represents a region of a wall 230. A person 210 is standing on a path 240 in front of the wall occluding part of the insertion region 200. The shaded the region for which a mask is needed is labelled as 220.

By identifying the features of in each image of the sequence of images that are foreground objects (not shown in the reference image), it is possible to mask the insertion image in the appropriate locations so as not to be inserted where the foreground objects should appear.

This is possible, because the transformation of the insertion image into the warped insertion image aligns the features of the insertion image with the locations of equivalent features in the corresponding image of the sequence of images.

A preferred method of inserting an insertion image into a sequence of images, comprises capturing a reference image. The sequence of images comprises an ordered sequence of images, including a first image and a second image. For the purpose of illustration, the reference image is aligned with the first image such that the features captured in the reference image are aligned with the equivalent features captured in the first image by virtue of the camera orientations for the two images being the same.

Using any of the methods set out above a first homographic transform from the first image to the second image is estimated, and the reference image is transformed using the first homographic transformation to form a warped reference image. By warping the reference image to form the warped reference image, the features captured in the reference image can be aligned for comparison with the equivalent features captured in the second image.

The warped reference image is compared with the second image to identify foreground objects. This is preferably done using the method described below and shown in FIG. 9.

The insertion image is also transformed using the first homographic transformation to form a warped insertion image. The warped insertion image is masked using the identified foreground objects and inserted into the second image to form a composite image.

For example, the composite image may be formed by substituting the pixels of the second image by the pixels of the warped insertion image that are not masked. In this way, the composite image appears to include the insertion image in the insertion region, seemingly behind any foreground objects.

One exemplary method of comparing the warped reference image with the second image to identify foreground objects is shown in FIG. 9, and comprises the following steps.

In step P10, the warped reference image and the second image are provided in a colour space having an intensity channel (sometimes referred to as a brightness, luminance or luma channel), which represents the intensity of each pixel. In addition to the brightness channel, two chrominance channels (essentially, colour channels independent of absolute intensity) may be provided, such as hue and saturation.

For example, the images (prior to any warping) may have been captured in the RGB colour space with three channels representing the intensity of red, green, and blue light, respectively. The pixel values may be transformed from the colour space in which they were captured to the new colour space having an intensity channel, e.g. the HSI colour space with three channels representing hue, saturation, and intensity, respectively.

In step P20, an intensity difference is calculated as between pixels of the warped reference image and corresponding pixels of the second image in the intensity channel. This need not be calculated for every pixel, but may be done only for the plurality of insertion region pixels corresponding to the insertion region. This provides a plurality of intensity differences corresponding to pixel locations in the second image. Essentially, this can result in a single-channel intensity difference image. Optionally, a blurring filter (preferably a Gaussian filter) may be applied to the single-channel intensity difference image. It has been found through experimentation that this can improve the robustness of the background subtraction method.

In step P30, the plurality of intensity differences are each compared with an intensity threshold. This indicates which insertion region pixels of the second image differ from the insertion region pixels in the warped reference image in the intensity channel by more than the intensity threshold.

In step P40, a colour difference is calculated as between pixels of the warped reference image and corresponding pixels of the second image in the intensity channel for each of the other two chrominance channels. The colour differences are calculated for the same pixels as the brightness differences. This provides a pair of colour differences corresponding to pixel locations in the second image. Again, this may only be done for the plurality of insertion region pixels corresponding to the insertion region.

In step P50, the plurality of colour differences are each compared with a colour threshold. This indicates which pixels of the second image that differ from the pixels in the warped reference image in the colour channel by more than the colour threshold. Optionally, this may be done by applying an operator to the pair of colour differences to find a single difference for comparison with the threshold. For example, the maximum value of the two chrominance components may be compared with the threshold (alternatively, the mean value may be compared).

In step P60, the pixels of the second image that differ from the pixels in the warped reference image in the intensity channel by more than the intensity threshold, and the pixels of the second image that differ from the pixels in the warped reference image in the colour channel by more than the colour threshold can be used to create a background segmentation image differentiating the background from foreground objects. For example, the background segmentation image may be a binary image in which 0 and 1 represent foreground and background objects (or vice versa) in at least the insertion region.

For example, the background segmentation image may be created by for each of the insertion region pixels, labelling the pixel as foreground where both the brightness difference exceeds the brightness threshold and the colour difference exceeds the colour threshold. Conversely, the other pixels are labelled as background.

Optionally, morphological filters can be applied to the background segmentation image for removing some or all of any noise.

In step P70, the warped insertion image can then be masked using the background segmentation image to form a masked warped insertion image.

It has been realised that the comparison of the background pixels of the insertion region (those that are similar as between an image of the sequence of images and the warped reference image) can provides an indication of a general bias across the reference image.

For example, if the sequence of images is of an outdoor scene over several hours, the background level of illumination will vary significantly. For example, an outdoor scene will appear brighter at noon than at 8 am. The average intensity value of pixels of that scene, even if not occluded, will therefore vary slowly over the sequence of images. The background pixels can provide a measure of that variation.

Accordingly, it is preferable that the methods include the step of modifying the reference image based on an image measure calculated over the background pixels of the insertion region.

For example, the method may include: calculating the average intensity of the background pixels of the insertion region of an image (the most recently received image) of the sequence of images; calculating the average intensity of the corresponding pixels of the reference image; comparing the calculated average intensity for the image of the sequence of images with the calculated average intensity for the reference image to calculate a difference; and modifying the entire reference image using the calculated difference.

An alternative image measure could be the colour temperature. In this way, the entire reference image could be modified such that the colour temperature of the background pixels of the insertion region of the reference image match those of the image (the most recently received image) of the sequence of images.

An alternative image measure could be the image histogram (wither just intensity or intensity for each colour). In this way, the entire reference image could be modified such that the histogram for the background pixels of the insertion region of the reference image matches the histogram of the image (the most recently received image) of the sequence of images.

Additional Filtering

In preferred embodiments, the step of inserting the masked warped insertion image into the second image comprises blurring the composite image in the vicinity of the edges of the mask. It has been found that this provides a better result for even static images.

Preferably, this may be done by applying a blurring filter, such as a Gaussian filter, to the background segmentation image.

It is also preferred that the masked warped insertion image be blurred to match any motion blur in the image into which it is inserted.

Selective Masking

As mentioned above, in some example embodiments, the insertion object is a three-dimensional model, and may be an animated three-dimensional model. A projection of the three-dimensional model at a particular moment in time may be calculated to produce an insertion image for each image of the sequence of images. In this way, a different insertion image (a different projection of the three-dimensional model) is modified where necessary to produce the modified insertion image for insertion into each image of the sequence of images. Whereas when the insertion object is two-dimensional, it is normally the case that it will be inserted into the background of a scene such that all foreground objects moving in that location of the scene are likely to occlude the inserted image, this is not always the case. When the inserted object is three-dimensional, for example, the object may be modified for insertion in largely the same way (one can imagine a cube being inserted into a video being warped by homographic transform to appropriately match the angle of the camera), but the object will be inserted at a particular depth in the scene, rather than be projected onto a region of the background. As a result, an inserted three-dimensional object will not always be behind a foreground object. This will depend on the foreground object's depth into the scene—relative to the insertion object.

In such an example, the mask described above in relation to steps 80, 90, and 100 of FIG. 1 may be used or not, depending on the relative location of the foreground object and the insertion object.

In a modified step 80, a foreground/background mask is created for each warped insertion image using the warped reference image. This can be done by comparing the warped reference image with the corresponding image in the sequence of images. Where the two images differ, then the pixel can be labelled in the foreground/background mask as foreground, and where the two images match, the pixel can be labelled as background. This is preferably done just for the insertion region (as it appears in the warped reference image).

Using the foreground labelled pixels, foreground objects may be identified. One way of doing this may be to group contiguous pixels as single objects. The height in the image of the lowest points of such objects will be indicative of depth into the scene.

For example, in a scene that represents a room, the lowest points of the people standing in the room will be their feet. The height of the (lowest of each pair of) feet in the image will indicate how close to the camera the person is.

Conversely, the height in the image of the lowest point of the insertion object represents its depth into the scene.

Accordingly, in step 90, the mask may be applied selectively for a foreground object only if the insertion object is inserted into the scene at a location deeper than the foreground object. In this way, each warped insertion image is masked using the foreground/background mask, to create a masked warped insertion image, with which a subset of pixels of the warped insertion image may be inserted into another image, only if its lowest point is higher in the image than the lowest point of the foreground object.

In step 100, each of the masked warped insertion images is inserted into the corresponding image of the sequence of images. Owing to the masking step, in each image of the sequence of images, any foreground objects that occlude the insertion region are retained and the pixels corresponding to the visible part of the insertion region are replaced by the pixels of the warped insertion image when the foreground object is located between the location into which the insertion object is inserted and the camera position.

1. A method of inserting an insertion object into a sequence of images, comprising:
receiving or capturing a sequence of images, the sequence of images comprising in order a first image, a second image, and a third image;
estimating a first homographic transform from the first image to the third image;
deriving a second homographic transform from the first image to the second image based on the first homographic transform;
transforming the insertion object using the first homographic transformation to form a first warped insertion image, and inserting the first warped insertion image into the third image of the sequence of images; and
transforming the insertion object using the second homographic transformation to form a second warped insertion image, and inserting the second warped insertion image into the second image of the sequence of images.

2. A method of claim 1 wherein:
the first homographic transform is representable as a first homography matrix; and
the second homographic transform is representable as a second homography matrix that is equal to the square root of the first homography matrix.

3. The method of claim 2, wherein the step of deriving a second homographic transform comprises deriving the square root of the first homography matrix to provide a second homography matrix that represents a second homographic transform from the first image to the second image.

4. The method of claim 2, wherein the step of estimating the first homographic transform comprises:
identifying in the first image a first plurality of image patches having a first size;
for each of the first plurality of image patches identifying a matching image patch in the third image,
identifying a first set of correlations between the locations of the first plurality of image patches and the locations of the respective matching image patches in the third image;
identifying in the first image a second plurality of image patches having a second size, the second size being bigger than the first size;
for each of the second plurality of image patches identifying a matching image patch in the third image;
identifying a second set of correlations between the locations of the second plurality of image patches and the locations of the respective matching image patches in the third image; and
estimating the first homographic transform using at least one of the first and second sets of correlations.

5. The method of claim 4, further comprising:
calculating first similarity scores between the first plurality of image patches in the first image and the respective matching image patches in the third image; and
comparing each of the first similarity scores with a first threshold and thereby providing a first confidence score for the first set of correlations;
calculating second similarity scores between the second plurality of image patches in the first image and the respective matching image patches in the third image;
comparing each of the second similarity scores with a second threshold and thereby providing a confidence score for the second set of correlations; and
the step of estimating the first homographic transform comprises using the one of the first and second sets of correlations that has the highest associated confidence score.

6. The method of claim 5, wherein the similarity scores are normalised by size of image patch and the first threshold is smaller than the second threshold.

7. The method of claim 1, further comprising:
calculating a plurality of homographic transforms, each homographic transform calculated based on neighbouring pairs of the sequence of images from the first image to a final image;
combining the plurality of homographic transforms to form a combined homographic transform;
applying the combined homographic transform to a reference image to form a warped reference image;
comparing the warped reference image with the final image to form a residual image; and
updating the combined homographic transform based on the residual image.

8. A method of inserting an insertion object into a sequence of images, comprising:
capturing a reference image;
capturing a sequence of images, the sequence of images comprising a first image and a second image;
comparing the reference image with the first image to identify any first foreground object(s) and first background region(s) in at least an insertion region of the first image;
masking an insertion image obtained from the insertion object using the identified first foreground objects;
inserting the masked insertion image into the first image to form a composite image;
adjusting the reference image based on the differences between the reference image and the first image in the first background regions and thereby forming an updated reference image;
comparing the updated reference image with the second image to identify any second foreground object(s) and second background region(s) in at least an insertion region of the second image;
masking an insertion image obtained from the insertion object using the identified second foreground objects; and
inserting the masked insertion image into the second image to form a composite image.

9. The method of claim 8, wherein adjusting the reference image comprises the steps of:
calculating an image measure using the pixels of the first background regions of the first image;
calculating an image measure using the corresponding pixels of the reference image;
comparing the image measure for the first image with the image measure for the reference image to calculate a difference; and
modifying the entire reference image using the calculated difference.

10. The method of claim 9, wherein:
the image measure is the average intensity and modifying the entire reference image using the calculated difference involves modifying the entire reference image by the average intensity difference; or
the image measure is the average colour temperature and modifying the entire reference image using the calculated difference involves modifying the entire reference image using the colour temperature difference; or
the image measure is the calculation of a variation in the image histogram and modifying the entire reference image using the calculated difference involves modifying the image histogram of the entire reference image such that the histogram of the pixels of the background regions of the second image and reference image match.

11. The method of claim 8, wherein the method further comprises:
calculating the average intensity of the pixels of the background regions of the first image;
calculating the average intensity of the corresponding pixels of the reference image;
comparing the calculated average intensity for the first image with the calculated average intensity for the reference image to calculate a difference; and
modifying the entire reference image using the calculated difference.

12. The method of claim 1, wherein the method is carried out using a processor connected to a digital camera.

13-15. (canceled)

16. A method of inserting an insertion object into a sequence of images, comprising:
capturing a reference image;
capturing a sequence of images, the sequence of images comprising in order a first image and a second image;
estimating a first homographic transform from the first image to the second image;
transforming the reference image using the first homographic transformation to form a warped reference image;
comparing the warped reference image with the second image to identify any foreground object(s) and background region(s) in at least an insertion region;
transforming the insertion object using the first homographic transformation to form a warped insertion image;
masking the warped insertion image using the identified foreground objects; and
inserting the masked warped insertion image into the second image to form a composite image.

17. The method of claim 16, wherein the step of inserting the masked warped insertion image into the second image comprises blurring the composite image in the vicinity of the edges of the mask.

18. The method of claim 16 or 17, wherein the step of comparing the warped reference image with the second image to identify foreground objects comprises:
providing the warped reference image and the second image in a colour space having an intensity channel and two colour channels;
calculating a intensity difference between a plurality of pixels of the warped reference image and the corresponding pixels of the second image in the intensity channel to provide a plurality of intensity differences;
calculating a colour difference between the plurality of pixels of the warped reference image and the corresponding pixels of the second image in the colour channel for the other two channels to provide a plurality of colour differences;
comparing each of the plurality of intensity differences with an intensity threshold;
comparing each of the plurality of colour differences with a colour threshold;
creating a background segmentation image differentiating the background from foreground objects based on the intensity and colour differences, wherein the step of masking the warped insertion image using the identified foreground objects comprises masking the warped insertion image using the background segmentation image.

19. The method of claim 18, wherein the background segmentation image is created by:
for each pixel, labelling the pixel as foreground where both the intensity difference exceeds the intensity threshold and the colour difference exceeds the colour threshold.

20. The method of claim 16, wherein the method further comprises:
calculating an image measure using the pixels of the background regions of the second image;
calculating an image measure using the corresponding pixels of the warped reference image;
comparing the image measure for the second image with the image measure for the warped reference image to calculate a difference; and
modifying the entire reference image using the calculated difference.

21. The method of claim 16, wherein:
the image measure is the average intensity and modifying the entire reference image using the calculated difference involves modifying the entire reference image by the average intensity difference; or
the image measure is the average colour temperature and modifying the entire reference image using the calculated difference involves modifying the entire reference image using the colour temperature difference; or
the image measure is the calculation of a variation in the image histogram and modifying the entire reference image using the calculated difference involves modifying the image histogram of the entire reference image such that the histogram of the pixels of the background regions of the second image and reference image match.

22. The method of claim 16, wherein the method further comprises:
calculating the average intensity of the pixels of the background regions of the second image;
calculating the average intensity of the corresponding pixels of the warped reference image;
comparing the calculated average intensity for the second image with the calculated average intensity for the warped reference image to calculate a difference; and
modifying the entire reference image using the calculated difference.

23. A method of inserting an insertion object into a sequence of interlaced images, comprising the steps of claim 1, wherein:
The sequence of images is a received a sequence of interlaced images, the sequence of interlaced images comprising in order a first interlaced image, and a second interlaced image, whereby the first interlaced image includes the first image interlaced with the second image and the second interlaced image includes the third image interlaced with the fourth image, wherein the first and third captured images are represented on one of the odd or even rows of the interlaced images and the second and fourth captured images are represented on the other of the odd or even rows of the interlaced images.

24. A method of inserting an insertion object into a sequence of images, comprising the steps of claim 1, wherein:
The third image is in the Nth position in the sequence of images;
the first homographic transform is representable as a first homography matrix; and
the second homographic transform is representable as a second homography matrix that is equal to the (N−1)th root of the first homography matrix.

25-27. (canceled)

28. The method of claim 8, wherein:
the method comprises defining a location for the insertion of the insertion object in each of the sequence of images; and
the step of masking an insertion image comprises:
evaluating the location(s) in the scene of any first foreground object(s);
comparing the defined location of the insertion object with the evaluated location(s) of the first foreground object(s) to identify occluding foreground object(s) that are located between the defined location of the insertion object(s) and the camera; and
masking the insertion image only for pixels corresponding to occluding foreground object(s).

29. The method of claim 28, wherein the step of comparing the defined location of the insertion object with the evaluated location(s) of the first foreground object(s) comprises comparing the height of the insertion object in each of the sequence of images with the height of the first foreground object(s).
